(19) United States
(12) Patent Application Publication
(10) Pub. No.: US 2025/0010510 A1
(43) Pub. Date: Jan. 9, 2025

(54) Punching die

(71) Applicant: WS Wieländer + Schill Professionelle Karosserie-Spezialwerkzeuge GmbH & Co. KG, Tuningen (DE)

(72) Inventor: Klaus REITZIG, Lüdenscheid (DE)

(73) Assignee: WS Wieländer + Schill Professionelle Karosserie-Spezialwerkzeuge GmbH & Co. KG, Tuningen (DE)

(21) Appl. No.: 18/762,857

(22) Filed: Jul. 3, 2024

(30) Foreign Application Priority Data
Jul. 5, 2023 (DE) 10 2023 117 727.3

(51) Int. Cl. B26F 1/14

(52) U.S. Cl. CPC B26F 1/14

(57) ABSTRACT

A punching die includes a mount. The mount includes an insert accommodated in the front end thereof. The insert includes the through hole of the punching die.

### CROSS-REFERENCE TO RELATED APPLICATION

This application claims the benefit of German Patent Application DE 10 2023 117 727.3, filed on Jul. 5, 2023, the content of which is incorporated in its entirety.

### TECHNICAL FIELD

The disclosure relates to a punching die and to a method for punching holes. The disclosure further relates to a punching tool which is used in particular for punching holes in the car body sector.

### BACKGROUND

It is well known to punch holes in car body panels. Especially if the body panel is accessible from both sides, making holes using a hydraulic punching tool, which holes are used for setting rivets in the event of repairs, for example, is less time-consuming and costly than drilling.

In particular in the case of high-strength body panels, especially a composite structure, the drilling of a hole is cumbersome. High-strength special drills have to be used, which wear out relatively quickly.

But punching holes into high-strength body panels is also problematic.

During punching, a punch cuts into the body panel and a punching die serves as a counterholder. With high-strength sheet metal, there is hardly any flow of the material occurring during the punching process when the punch cuts into it. Rather, the punching slugs are virtually broken out.

The load on the cutting edge of the punch is enormous. Published patent application DE 10 2013 114 806 A1 (inventor Klaus Reitzig) discloses a punch on which an annular punch crown can be placed. The punch crown can be removed after a punching operation and can replaced with a new punch crown. This ensures that a punch with a sufficiently sharp cutting edge is used for each punching operation. As a result, the dimensional accuracy of the punched holes does not suffer from wear on the punch. At the same time, punching holes in particular into high-strength structural body parts is more cost-effective in this way, as only the punch crown needs to be replaced.

### SUMMARY

The present application further improves the precision of punching holes, especially into high-strength car body panels. This is achieved by a punching die as disclosed and claimed.

The disclosure relates to a punching die which is used in particular for a hydraulic tool for punching holes into car body panels, in particular high-strength car body panels.

The punching die comprises a mount.

The mount is configured for being connected to a punching tool. The mount may in particular comprise a shank that serves for coupling it to the punching tool.

An insert is accommodated in the front end of the mount, which insert comprises the through hole of the punching die.

The punching die, which will simply also be referred to as “die” below, thus consists of at least two parts and comprises the mount and the insert, and the insert comprises the through hole and the engagement surface for the workpiece.

Preferably, the insert protrudes from the mount. This means that only the insert will come into contact with the tool during a punching operation.

It has been found that the edge of the through hole, on which the workpiece comes into contact during punching, plays a surprisingly crucial role in the dimensional accuracy of the punched hole.

In particular, the edge of the through hole, on which the workpiece engages, appears to play an important role for the quality of the punching process also on the side of the die.

The insert is preferably annular, in particular in the form of a ring having a circular cylindrical outer perimeter.

According to one embodiment, the through hole of the insert has a diameter ranging from 3 to 15 mm.

According to a preferred embodiment, the insert is clamped in a recess of the mount.

More particularly, the insert is designed so as to establish an interference fit in the recess.

Thus, the insert is fixed in the recess by being clamped therein. In order to replace the insert, it can be stamped out of the recess. For this purpose, the mount preferably has a through hole below the insert.

In a further refinement, a circumferential groove is provided in the recess, into which an elastic ring is inserted, in particular an O-ring.

The elastic ring also serves to clamp the insert in place. In a preferred embodiment, both the elastic ring and an interference fit are provided for the clamping connection.

The insert is preferably made of a harder material than the mount.

More particularly, the insert may be made of a hardened alloy exhibiting an HRC hardness of greater than 60, preferably 60 to 65 (according to DIN EN ISO 6508-1-2016-12).

The hardness of the material of the mount preferably differs by at least 5 HRC hardness levels.

The mount may in particular have an HRC hardness of 50 to 58.

The insert is preferably through-hardened. The mount may be unhardened or only surface-hardened.

This means that a harder but more brittle material is used for the insert. The material of the mount is softer, but has a higher elongation at break, which prevents the risk of sudden component failure due to breakage.

According to one embodiment, the recess is formed as a blind hole with a collar that engages below the insert.

The collar surrounds the insert from below. Preferably, however, the collar ends radially in front of the inner edge of the through hole of the insert.

This makes a portion of the underside of the insert accessible so that the insert can be knocked out.

In a preferred embodiment, the through hole has an undercut.

The undercut may in particular have a conical shape adjacent to a circular cylindrical section of the through hole.

The side wall of the undercut may in particular extend at an angle of 10° to 20° relative to the central axis of the insert.

In one embodiment, the insert has a ratio of wall thickness to outer diameter (largest outer diameter) of 0.1 to 0.5, preferably 0.2 to 0.3.

So, preferably, the wall of the insert is comparatively thick.

The ratio of height to outer diameter of the insert is preferably 0.2 to 2, more preferably 0.4 to 0.8.

Thus, the insert preferably does not come in the form of a flat disk, but as a component with a relatively large height, which largely prevents distortion of the insert during punching.

Furthermore, the disclosure relates to a punching tool which comprises the die as described above.

The punching tool in particular is a hydraulic tool comprising an exchangeable punching die and an exchangeable punch.

The disclosure furthermore relates to a method for punching holes, in particular into high-strength car body panels.

According to the method, the punching die as described above is used.

After a first hole has been punched, the insert is exchanged and then a second hole is punched.

Regular replacement of the insert allows to ensure consistent dimensional accuracy of the punched holes.

### BRIEF DESCRIPTION OF THE DRAWINGS

The subject-matter of the invention will now be explained in more detail with reference to an embodiment as shown in the drawings of FIGS. 1 to 3.

FIG. 1 is a side view of a punching die.

FIG. 2 is a central longitudinal sectional view of the punching die.

FIG. 3 shows the punching die as well as the punch used in cooperation with the punching die.

### DETAILED DESCRIPTION

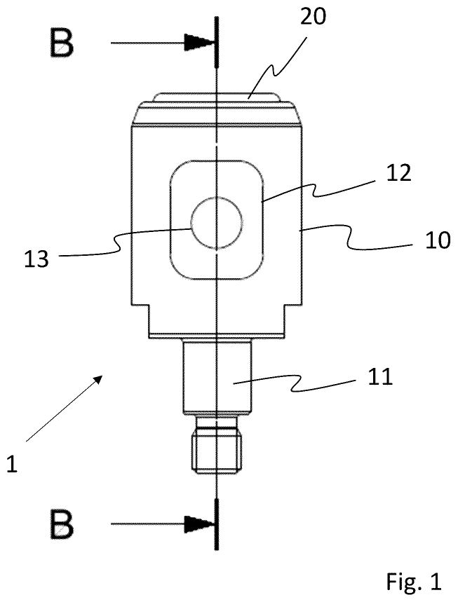

FIG. 1 shows a side view of an exemplary embodiment of a punching die 1.

The die 1 comprises a mount 10 with a shank 11 on the rear side thereof, through which the mount 10 can be fixed to a hydraulic pressing tool.

The mount 10 preferably has a circular cylindrical shape.

The mount 10 is hollow inside, and in the present exemplary embodiment it has a lateral opening 12 and a through hole 13.

Lateral opening 12 allows to remove the punching slug. If a part gets jammed, it can be pushed out from the opposite side using a tool.

At its front end, the mount 10 includes an insert 20 accommodated therein, which insert defines the engagement surface for the workpiece.

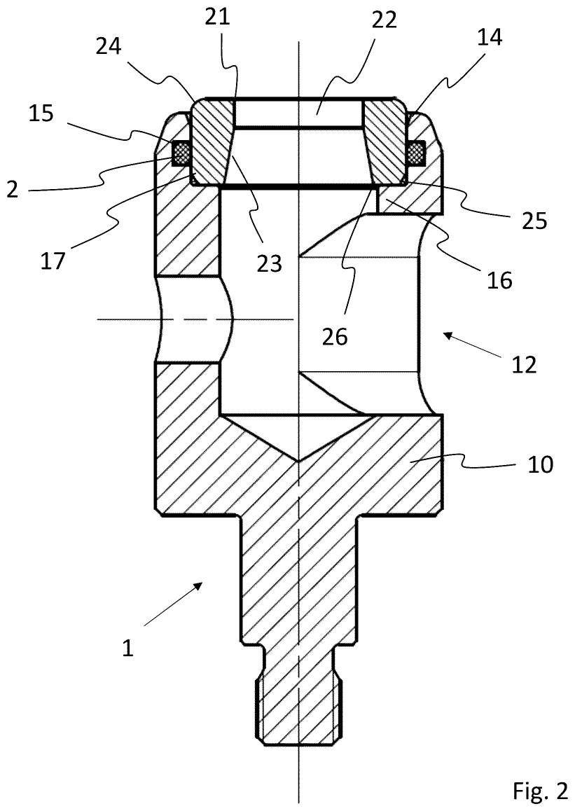

FIG. 2 is a central longitudinal sectional view along line B-B of FIG. 1.

The insert 20 sits in a recess 17 of the mount 10.

The insert 20 is clamped in the recess 17 by virtue of an interference fit.

Furthermore, the recess 10 has an internal groove 15 into which an O-ring 2 is inserted.

The recess 17 forms a blind hole with a collar 16 which engages below the insert 20 and thus supports the insert 20.

The collar 16 terminates at a distance before the inner edge 26 of the insert 20. This allows a suitable tool to engage on the underside of the insert 20 in order to knock it out.

For example, a tool having an expandable head and a movable weight which serves as a pull hammer, can be used to knock out the insert 20 (not shown).

On its front end, the recess 17 has a conical insertion section 14. This makes it easier to introduce the insert 20.

The insert 20 has a circular cylindrical outer contour.

Its front edge 24 is rounded.

The insert 20 protrudes from the recess 17.

The inner lower edge 25 is beveled, in particular conical, which also makes it easier to introduce the insert 20.

For punching it is crucial that the edge 21 of the through hole 22, on which the workpiece comes into contact, is sufficiently sharp.

The through hole 22 has a circular cylindrical section followed by an undercut 23. In the undercut section, the diameter of the through hole 22 widens. This makes it easier for the punched-out piece of sheet metal to fall out.

Compared to the mount 10, the insert 20 is made of a harder, but at the same time more brittle material with lower elongation at break.

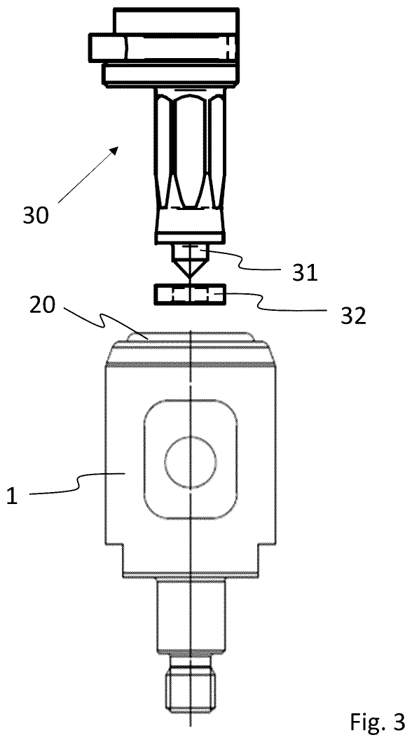

FIG. 3 shows how the die 1 is used in a corresponding tool.

In addition to the die 1, a punch 30 is mounted to the hydraulic tool (not shown).

In the present exemplary embodiment, the punch comprises a mandrel 31 on which a punch crown 32 is placed.

The punch crown 32 defines the counterpart to the die 1, in particular to the insert 20.

With the punch crown 32 leading, the punch 30 cuts into the sheet metal and moves into the through hole of the insert 20.

As mentioned above in the introductory part, there is less cutting of the punching die 30 occurring in the case of high-strength sheet metal and sheet metal pairings. The punched-out piece of sheet metal, also known as a punching slug, is virtually broken out.

The invention made it possible to further improve the dimensional accuracy of the holes punched into a car body panel. Furthermore, once the edge of the through hole in the die becomes worn, only the insert needs to be replaced.

### LIST OF REFERENCE NUMERALS

1 Punching die/die
2 O-ring
10 Mount
11 Shank
12 Lateral opening
13 Through hole
14 Insertion section
15 Groove
16 Collar
17 Recess
20 Insert
21 Inner edge
22 Through hole
23 Undercut
24 Edge
25 Edge
26 Edge
30 Punch
31 Mandrel
32 Punch crown

What is claimed is:

1. A punching die comprising a mount,
wherein the mount includes an insert that is accommodated in a front end of the mount, and
wherein the insert comprises a through hole of the punching die.

2. The punching die of claim 1, wherein the insert is in form of a ring.

3. The punching die of claim 1,
wherein the insert is clamped into a recess of the mount, and
wherein the insert is formed so as to establish an interference fit in the recess.

4. The punching die of claim 3, wherein the recess includes a circumferential groove in which an elastic ring is accommodated.

5. The punching die of claim 1, wherein the insert is made of a harder material than the mount, in particular of a material exhibiting an HRC hardness of greater than 60 according to DIN EN ISO 6508-1-2016-12.

6. The punching die of claim 1, wherein the insert is configured so as to be removable from the mount.

7. The punching die of claim 3, wherein the recess is in the form of a blind hole with a collar engaging below the insert.

8. The punching die of any of claim 1,
wherein the through hole has an undercut; and/or
wherein the insert has a ratio of wall thickness to outer diameter of 0.2 to 0.3; and/or
wherein the insert has a ratio of height to outer diameter of 0.4 to 0.8.

9. A punching tool, comprising the punching die according to claim 1.

10. A method for punching holes into high-strength car body panels, comprising:
punching a first hole with the punching die according to claim 1; and thereafter exchanging the insert and punching a second hole.
